(19) United States
(12) Patent Application Publication
(10) Pub. No.: US 2021/0006063 A1
(43) Pub. Date: Jan. 7, 2021

(54) SYSTEMS AND METHODS FOR PROGRESSIVELY SWITCHED SOLID-STATE DIRECT CURRENT CIRCUIT BREAKERS

(71) Applicant: North Carolina State University, Raleigh, NC (US)

(72) Inventors: Landon K. Mackey, Raleigh, NC (US); Iqbal Husain, Raleigh, NC (US); Chang Peng, Raleigh, NC (US)

(21) Appl. No.: 16/919,284

(22) Filed: Jul. 2, 2020

Related U.S. Application Data
(60) Provisional application No. 62/869,739, filed on Jul. 2, 2019.

(51) Int. Cl. H02H 9/02; H02H 1/00

(52) U.S. Cl. CPC H02H 9/025; H02H 1/0092; H02H 1/0007

(57) ABSTRACT

Disclosed herein are systems and methods for progressively switched solid-state direct current circuit breakers (“DCCBs”). According to one embodiment, a progressively switched solid-state DCCB includes a fault-sensing device to sense a fault condition in the current provided to a load is disclosed. A controller is configured to receive fault-sensing information from the fault-sensing device and provide control signals for progressively switching the DCCB based on the fault-sensing information. At least two stages, each include two or more series connected power electronic switches, two or more power electronic switches configured to interrupt control current flow through the power electronic switches responsive to receiving one of the control signals, and a voltage clamping device configured to clamp a voltage across the two or more power electronic switches when current flow through the switches is interrupted. The at least two stages are configured to progressively clamp voltage based on the control signals.

### PRIORITY CLAIM

This application claims the benefit of U.S. Provisional Patent Application No. 62/869,739, filed on Jul. 2, 2019, the entire content of which is incorporated herein by reference.

### TECHNICAL FIELD

The present invention relates generally to the field of electrical circuit breakers, and particularly, to a system and method for progressively switched solid-state direct current (“DC”) circuit breakers (“DCCB”).

### BACKGROUND

DC systems are gaining attention with high interest in distributed renewable energy resources, electrified transportation, and electric ships. DC does not experience a natural current zero crossing; therefore, arc extinguishing does not occur during mechanical contact separation. Prior systems address this inability to quench a DC arc using electromechanical switchgear that is large, expensive, and slow. Conventional electromechanical switchgear commonly operates in tens of and up to hundreds of milliseconds. DC systems require faster fault protection due to the decoupling of rotational generation and replacement of power transformers with power electronics, resulting in short fault current rise times.

The short fault current rise time can be improved by using smaller and faster solid-state DCCBs, which isolate DC fault current in microseconds, rather than in tens of milliseconds. However, these solid-state DCCBs place semiconductors in the load current path that consume power and often require active cooling for heat dissipation. Wide-bandgap (“WBG”) devices, such as Silicon Carbide (“SiC”) and Gallium Nitride (“GaN”), have lower parasitic inductance and capacitance than their silicon counterparts and can achieve a rated blocking voltage of up to several kilovolts, thereby improving protection device performance. The use of WBG devices achieves the desired blocking voltage while requiring fewer series-connected solid-state devices, thereby reducing power consumption and cooling requirements. The increased speed capabilities of solid-state DCCBs shift the limiting factor for fault isolation to fault detection time, and the transient surge and subsequent dissipation across the protective device. This destructive voltage surge can reach several times the nominal rated voltage, which places undue strain on components. These limitations of DC systems require fast yet controlled DC fault isolation.

Accordingly, in order to achieve fast and controlled DC fault isolation, a system and method for progressively switched solid-state DCCBs are needed.

### SUMMARY

This SUMMARY is provided to introduce in a simplified form, concepts that are further described in the following detailed descriptions. This SUMMARY is not intended to identify key features or essential features of the claimed subject matter, nor is it to be construed as limiting the scope of the claimed subject matter.

According to an embodiment, a progressively switched solid-state direct current circuit breaker (“DCCB”) includes a fault-sensing device to sense a fault condition in the current provided to a load. A controller is configured to receive fault-sensing information from the fault-sensing device and provide control signals for progressively switching the DCCB based on the fault-sensing information. At least two stages each include two or more series connected power electronic switches, two or more power electronic switches configured to interrupt control current flow through the power electronic switches responsive to receiving one of the control signals, and a voltage clamping device configured to clamp a voltage across the two or more power electronic switches when current flow through the switches is interrupted. The at least two stages are configured to progressively clamp voltage based on the control signals. At least one discharge component is configured to provide a path to dissipate inductive current flow when the fault condition is cleared.

According to an embodiment, the controller includes at least one processor.

According to an embodiment, the DCCB includes a driver operatively connected to the power electronic switches to drive the power electronic switches based on control signals from the processor.

According to an embodiment, the at least one processor includes a digital signal processor (“DSP”).

According to an embodiment, the voltage clamping device is at least one of a varistor, fixed value resistor, resistive-capacitive snubber circuit, zener diode, gas discharge tube, and semiconductor suppressor.

According to an embodiment, the varistor is a metal oxide varistor (“MOV”).

According to an embodiment, the power electronic switch is at least one of a field effect transistor (“FET”), insulated gate bipolar transistor (“IGBT”), integrated gate-commutated thyristor (“IGCT”), injection-enhanced gate transistor (“IEGT”), and gate turn-off thyristor (“GTO”).

According to an embodiment, the field effect transistor is a metal oxide field effect transistors (“MOSFET”).

According to an embodiment, each stage includes a either a singular, or a plurality of power control switches arranged in parallel.

According to an embodiment, the discharge component is a diode.

According to an embodiment, the DCCB includes a relay configured to provide galvanic isolation to the DCCB.

According to an embodiment, the DCCB includes at least one of manual open and manual close, overcurrent, rate of current rise, under-voltage, ground fault current interruption (“GFCI”), adaptive trip settings, and over or under power trip.

According to an embodiment, a method of progressively switching a DCCB includes sensing a fault condition in DC current provided to a load and determining that a DC current threshold is exceeded for current provided to the load. Responsive to determining that the current threshold is exceeded, a series of stages is controlled to progressively clamp voltage to limit current flow to the load. A path to dissipate inductive current flow is provided when the fault condition is cleared

According to an embodiment, the method includes providing galvanic isolation to the DCCB.

According to an embodiment, a non-transitory computer-readable storage medium storing instructions to be implemented by a controller having at least one processor is disclosed for progressively switching a DCCB via control signals. The instructions, when executed by the at least one processor, cause the controller to perform a method including sensing a fault condition in DC current provided to a load and determining that a DC current threshold is exceeded for current provided to the load. The method further includes responsive to determining that the DC current threshold is exceeded, controlling a series of stages to progressively clamp voltage to limit current flow to the load. The DCCB provides a path to dissipate inductive current flow when the fault condition is cleared.

According to an embodiment, the DCCB includes a fault-sensing device to sense the fault condition and at least two stages. Each stage includes two or more series connected power electronic switches. The two or more power electronic switches are configured to interrupt control current flow through the power electronic switches responsive to receiving one of the control signals. Each stage also includes a voltage clamping device configured to clamp a voltage across the two or more power electronic switches when current flow through the power electronic switches is interrupted.

According to an embodiment, the at least two stages are configured to progressively clamp voltage based on the control signals.

According to an embodiment, the DCCB further includes at least one discharge component configured to provide a path to dissipate inductive current flow when the fault condition is cleared.

According to an embodiment, the DCCB further includes a driver operatively connected to the power electronic switches to drive the power electronic switches based on control signals from the processor.

According to an embodiment, the DCCB further includes a relay configured to provide galvanic isolation to the DCCB.

### BRIEF DESCRIPTION OF THE DRAWINGS

The present embodiments are illustrated by way of example and are not intended to be limited by the figures of the accompanying drawings. In the drawings:

FIG. 1A and FIG. 1B depict graphs illustrating comparison of typical direct current (“DC”) and alternating current (“AC”) fault differences during short circuit fault conditions in accordance with embodiments of the present disclosure.

FIG. 2 depicts a graph illustrating a comparison of progressive switching voltage and current simulation output of 1, 4, and 8 switching steps in accordance with embodiments of the present disclosure.

FIG. 3A depicts a schematic diagram illustrating a progressively switched solid-state four-stage direct current circuit breaker (“DCCB”) in accordance with embodiments of the present disclosure.

FIG. 3B depicts a schematic diagram illustrating a sample configuration of parallel power electronic devices for higher current handling capability devices for higher current handling capability in accordance with embodiments of the present disclosure.

FIG. 3C depicts a printed circuit board (“PCB”) diagram illustrating a four-stage, 380 volt DC, progressively switched solid-state DCCB in accordance with embodiments of the present disclosure.

FIG. 4A depicts a two-stage DCCB with digital signal processor (“DSP”) and power supply in accordance with embodiments of the present disclosure.

FIG. 4B depicts a four-stage DCCB illustrating sensing inputs in accordance with embodiments of the present disclosure.

FIG. 5A depicts a schematic diagram illustrating a DCCB in accordance with embodiments of the present disclosure.

FIG. 5B depicts a graph illustrating waveforms for current and voltage during switching of the DCCB of FIG. 5A in accordance with embodiments of the present disclosure.

FIG. 6A depicts a graph illustrating voltage waveforms for a two-stage progressively switched DCCB in accordance with embodiments of the present disclosure.

FIG. 6B depicts a graph illustrating current waveforms for the two-stage progressively switched DCCB of FIG. 6A in accordance with embodiments of the present disclosure.

FIG. 7 depicts a diagram illustrating a four-stage progressively switched 380-volt DCCB test bench in accordance with embodiments of the present disclosure.

FIG. 8 depicts a diagram illustrating infrared imaging on the four-stage progressively switched DCCB of FIG. 7 during continuous operation in accordance with embodiments of the present disclosure.

FIG. 9 depicts a graph illustrating current and voltage waveforms of the four-stage progressively switched DCCB of FIG. 7 in accordance with embodiments of the present disclosure.

FIG. 10 depicts another graph illustrating current and voltage waveforms of the four-stage progressively switched DCCB of FIG. 7 in accordance with embodiments of the present disclosure.

FIG. 11 depicts another graph illustrating current and voltage waveforms of the four-stage progressively switched DCCB of FIG. 7 in accordance with embodiments of the present disclosure.

FIG. 12 depicts a flowchart illustrating a control algorithm for a multi-stage progressively switched DCCB in accordance with embodiments of the present disclosure.

FIG. 13A through FIG. 13D depict graphs illustrating current and voltage waveforms during four-stage progressive shutdown at 250 volts in accordance with embodiments of the present disclosure.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to “one embodiment” or “an embodiment” in the present disclosure can be, but not necessarily are, references to the same embodiment and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described, which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Disclosed herein are systems and methods for progressively switched solid-state direct current circuit breakers

DC systems have lower system inductance than their alternating current (“AC”) counterparts due to power electronic decoupling of motor windings, absence of power transformers, and lower transmission distances. Lower inductance means fault current rises faster. The power electronic converters that supply DC distribution systems are capable of sustaining 2-3 times nominal current for several milliseconds, where rotational power systems are capable of feeding fault currents of 20-30 times the nominal for several tens of milliseconds. Because the power electronics inverters are unable to sustain high-magnitude and long-duration faults the way AC synchronous systems are able to they require high-speed fault isolation.

Motors decoupled from the distribution grid with variable speed drives lower the network inductance in DC systems. Additionally, DC systems do not have wire wound power transformers due to a stationary magnetic field. DC systems are most widely proposed for shorter distribution distance applications, which results in low line inductance, such as: DC microgrids, last mile DC distribution, electric ship propulsion, non-synchronous generation such as wave energy conversion (“WEC”), data centers, and islanded applications such as oil fields and platforms.

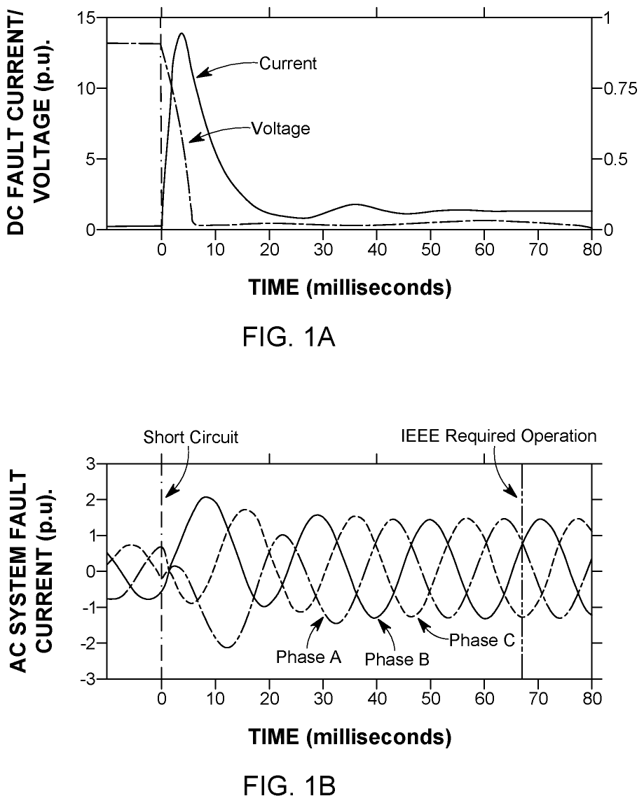

These characteristics of DC distribution systems result in low system inductance, which in turn results in short circuit fault current rising quickly. IEEE Std C37.12.1 defines the minimum operation time for an enclosed low voltage AC power circuit breaker as 67 milliseconds, as illustrated in FIG. 1A and FIG. 1B in accordance with embodiments of the present disclosure. However, the characteristics of DC systems fed by power electronic converters result in runaway currents and voltage collapse in the system in this time period. The waveforms, shown in FIG. 1 below are typical faults but will widely vary based on system dynamics, distributed resources, voltage regulator operation, and DC offset. Further, IEEE Std C37.12 defines the minimum operation time for heavy-duty low-voltage DC circuit breakers up to 1,200 volts as 53 milliseconds; however, it is important to note that this heavy-duty rating is for 1,200-10,000 ampere breaker frame size. Low-voltage, low-current DCCB time metrics are not standardized at this time.

The rate of current rise (di/dt), shown in Equation 1 below, and total fault current as a function of time, shown in Equation 2 below, show the contribution of system inductance to fault current rise rate and total fault current. As system inductance becomes lower, the fault current ramp rate, di/dt, and total fault current increase.

$$\begin{matrix}\frac{di}{dt} ( t ) = \frac{{V}_{Source} - ( {I}_{L} * {R}_{eq} )}{{L}_{eq}} & Equation 1 \\ {i}_{Fault} ( t ) = \frac{{V}_{Source}}{{R}_{eq}} ( 1 - {e}^{\frac{- Rt}{L}} ) & Equation 2\end{matrix}$$

Additionally, parasitic capacitance in the system contributes to fault current rise. Connected power electronic converters output capacitors, terminal capacitance, and long cable runs contribute to the total capacitance in the system. This is shown in Equation 3 below for the fault current rise as a function of time and Equation 4 below for fault current decay as a function of time. Note that iₚ=short-circuit current, tₚ=time to peak, τ₁=rise time constant, τ₂=decay time constant, and τ=RC=1/2πƒ.

$$\begin{matrix}{i}_{c 1} ( t ) = {i}_{p} \frac{1 - {e}^{\frac{- t}{{τ}_{1}}}}{1 - {e}^{\frac{- {i}_{p}}{{τ}_{1}}}} & Equation 3 \\ {i}_{c 2} ( t ) = {i}_{p} [ ( 1 - α ) {e}^{\frac{- ( t - {t}_{p} )}{τ}} + α ] & Equation 4\end{matrix}$$

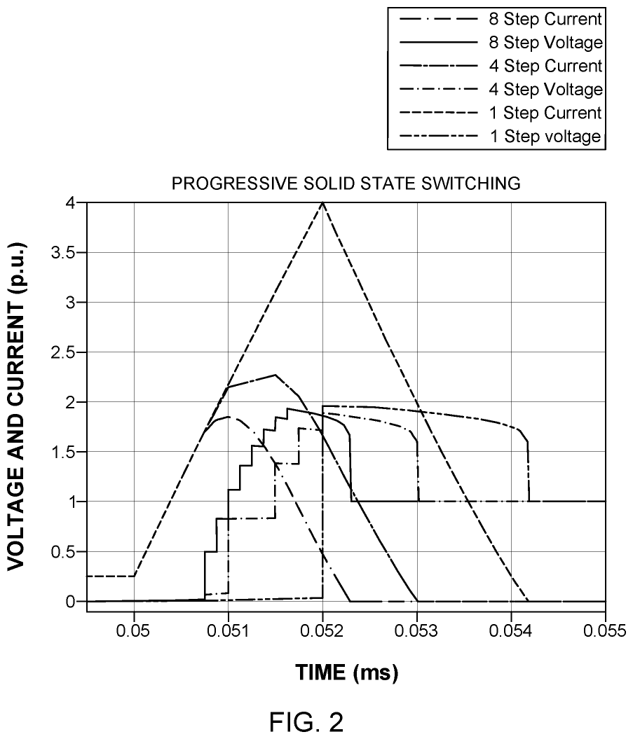

A conventional single-stage DCCB current rise to 4 times nominal is illustrated in FIG. 2 in accordance with embodiments of the present disclosure. However, according to an embodiment, a four-step or eight-step progressive DCCB observes a 2-time nominal transient voltage surge and isolates fault current 28% and 45% faster, respectively. Progressive switching allows flexible fault detection time and reduces the strain on components in the DCCB, allowing faults to be isolated with smaller and less expensive devices.

According to an embodiment, to achieve high-voltage shutdown in solid-state DCCBs, series-connected semiconductor switches are cascaded to reach the desired voltage withstand capability. Energy balancing between the devices can ensure safe shutdown without causing damage. Rapid single-stage shutdown can create a large voltage surge on the system and relies upon one metal oxide varistor (“MOV”) to clamp the voltage surge, creating a single point of failure. As grid-connected power electronics continue to evolve, many now demonstrate current limiting during a fault, preventing damage to the converter and connected equipment while attempting to maintain continuity of power for extremely short duration faults or system surges. Accordingly, a solid-state DCCB that limits current during a fault, minimizes the system strain due to voltage surge, and is capable of high blocking voltages is provided according to an embodiment to address the aforementioned fault characteristics.

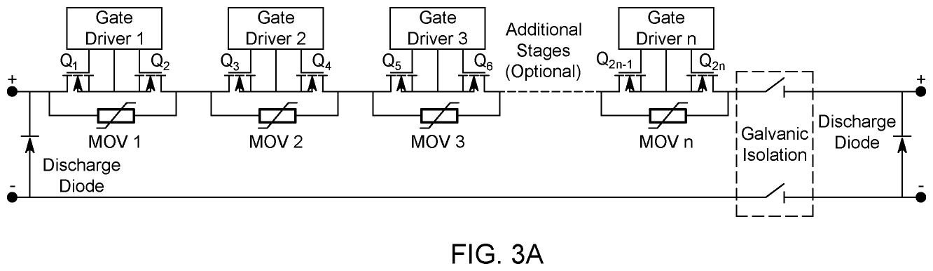

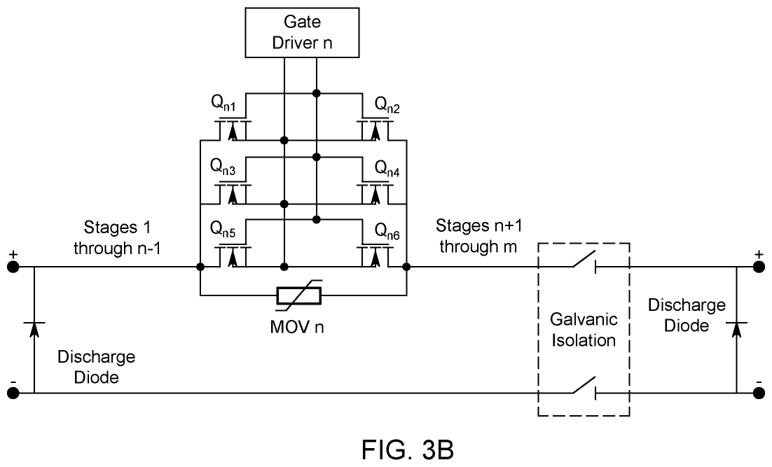

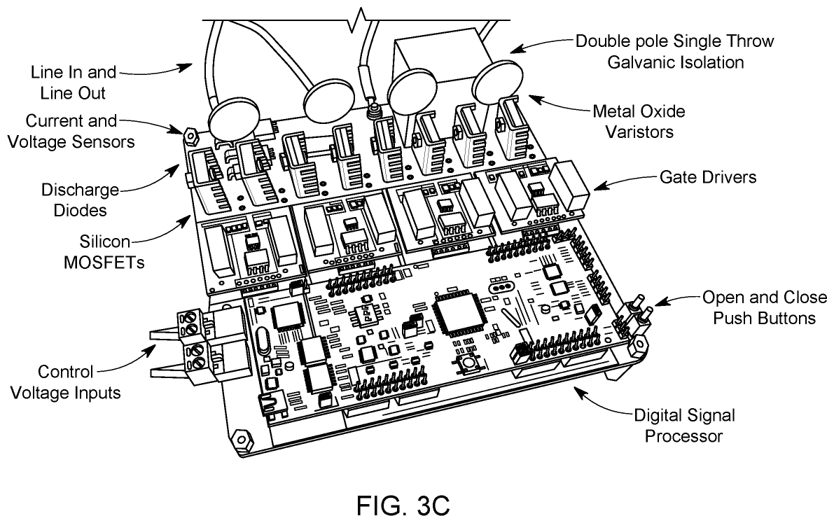

In an embodiment, a four-stage, bidirectional progressively switched DCCB prototype is provided to meet the needs of modern distributed renewable energy resource (“DRER”) rich systems as represented in the schematic of FIG. 3A. The prototype demonstrates a four-stage progressive shutdown with a single series of metal oxide field effect transistors (“MOSFETs”). Although MOSFETs are shown and described in the exemplary embodiment herein, other power electronic switches may also be used as the switching device to include, but not limited to, insulated gate bipolar transistor (“IGBT”), integrated gate-commutated thyristor (“IGCT”), injection-enhanced gate transistor (“IEGT”), and gate turn-off thyristor (“GTO”). Additional stages of MOSFETs may also be connected in series to achieve higher voltage withstand capabilities as shown in FIG. 3A as “Additional Stages (Optional).” This concept is expandable to several parallel MOSFET strings to lower the on-state power consumption due to device RDS,ON and increase current capacity, as illustrated in the schematic of FIG. 3B. A prototype implemented in printed circuit board (PCB) form in the diagram of FIG. 3C.

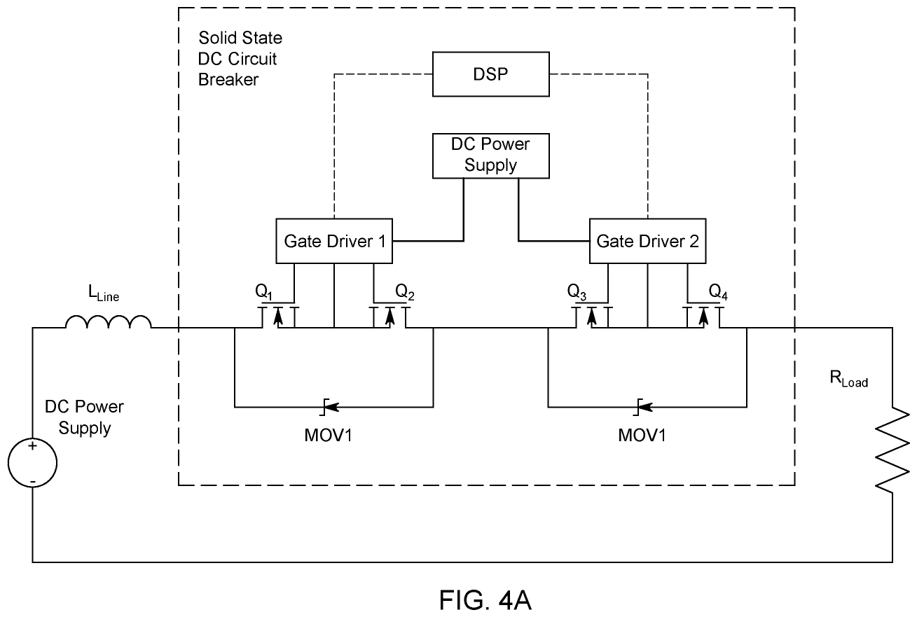

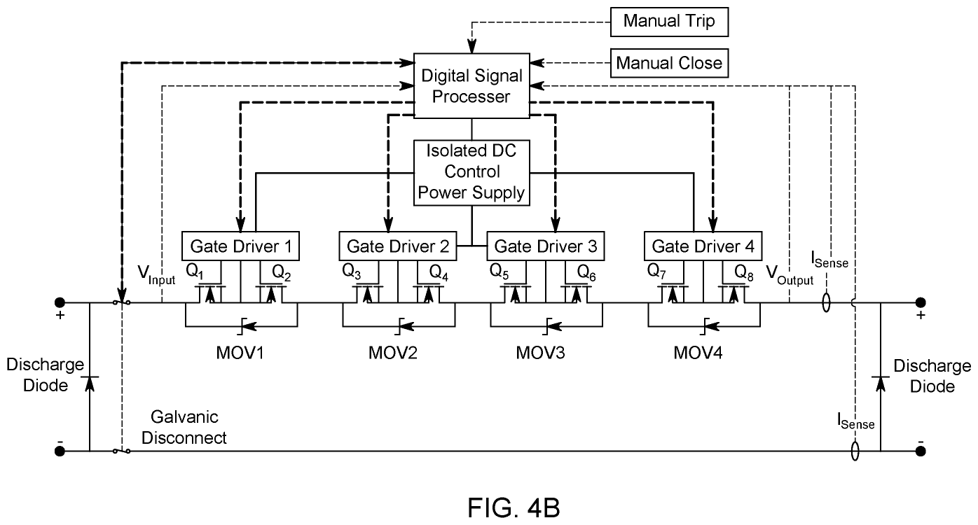

FIG. 4A and FIG. 4B illustrate a two-stage and four-stage DCCB, respectively, according to additional embodiments. One or more isolated DC power supplies can provide control power (such as 12 VDC) to the gate drivers and power to a digital signal processor (“DSP”) (such as an onboard 5 VDC converter and 3.3 VDC). The DSP can provide the necessary processing to achieve all control, sensing, and indicating functions, including control of gates, such as by controlling the gate drivers. Although a DSP is shown and described, a general purpose processor or other types of processors may be used instead. Additionally, processing duties may be shared or replicated among multiple processors. Each gate driver operates a pair of common-source connected MOSFETs to provide simplicity in bidirectional power flow, and MOVs at each stage clamp the voltage across the MOSFET pairs.

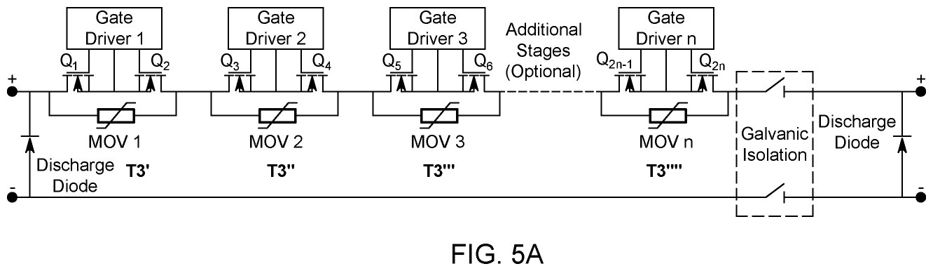

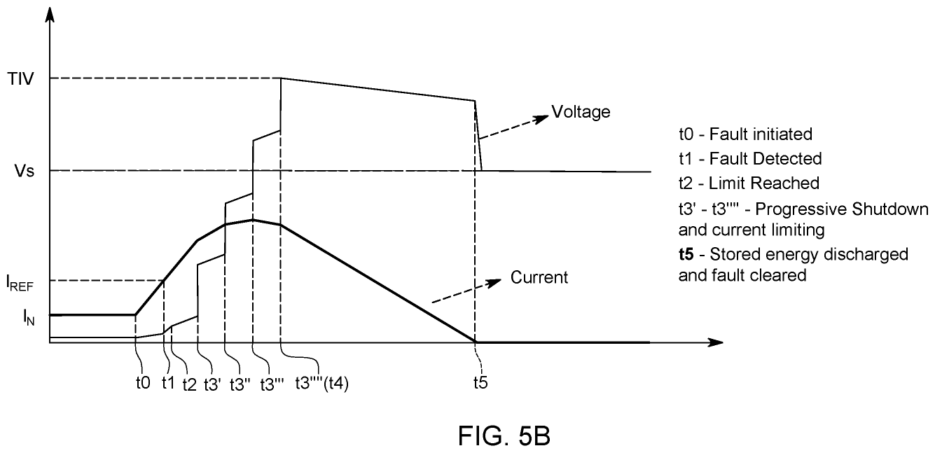

FIG. 5A and FIG. 5B illustrate the effects on current and voltage over time as a four-stage DCCB progressively switches each stage after a fault is detected according to an embodiment. FIG. 5A re-depicts a portion of the schematic diagram of FIG. 4B illustrating the DCCB. FIG. 5B depicts a graph illustrating waveforms for current and voltage during switching of the DCCB of FIG. 5A.

In normal operation current is provided from a DC power source (not shown) on the left to a load (not shown) on the right through MOSFETS Q₁-Q₈. When a fault occurs a current surge is sensed (Iₛₑₙₛₑ) by one or more current sensing devices and calculated by the DSP. The DSP determines the existence of the overload condition and, based on programmed commands stored in either an internal or external memory, the DSP controls gate drivers 1-4 to open respective MOSFETs Q₁-Q₈ based on the sensed current value. At time t₀ a fault is initiated and at time t₁ the fault is sensed. At time t₂ the predetermined threshold is met and at times t_{3′} to t_{3″″}, progressive shutdown is occurs to limit current and isolate the fault. In one embodiment, at time t_{3′} MOSFETS Q₁ and Q₂ are opened, forcing voltage to be clamped across MOV₁, at time t_{3″} MOSFETS Q₃ and Q₄ are also opened, forcing voltage to be clamped across MOV₂, at time t_{3′″} MOSFETS Q₅ and Q₆ are also opened, forcing voltage to be clamped across MOV₃, and at time t_{3″″} MOSFETS Q₇ and Q₈ are also opened, forcing voltage to be clamped across MOV₄. The order of progressive shutdown (T3′, T3″, T3′″, and T″″) can be different according to other embodiments. At time t₅, the fault is cleared and the stored energy is discharged through the discharge diodes.

In an embodiment, the MOV clamping and varistor voltages dictate the sequenced voltage steps. MOVs should be sized appropriately to ensure the voltage limit of the MOSFETs (V_{MOSFET}) are not exceeded to prevent shoot through of the semiconductor device such that V_{clamp}<V_{MOSFET}. However, the combined varistor voltages at 1 milliamp DC test current should exceed the maximum voltage in Equation 5 below, where n is the number of stages, so that that will be observed across the circuit breaker to prevent current leakage following isolation. Although MOVs are shown and described, other devices providing the necessary voltage clamping and energy dissipation can be employed, such as fixed value resistors, resistive-capacitive snubber circuits, zener diodes, gas discharge tubes, or semiconductor suppressors.

$${\sum }_{i = 1}^{n} {V}_{varistor} > {V}_{ma x , system} \qquad Equation 5$$

Energy absorption by the MOV should also be determined to ensure the device can withstand the energy surge during isolation. The instantaneous pulse energy (i²t) is given in Equation 6 below for the MOV in each stage and the total energy (E) absorbed by the MOV is given in Equation 7 below, where (v) is the varistor voltage, (iₚ) is the peak current at the beginning of the step, (i_{b}) is the decayed current at the end of the step, (t) is the time of each stage, and K is a varistor constant.

$$\begin{matrix}{i}^{2} t = ( \frac{1}{3} ) ( {i}_{p}^{2} + {i}_{p} ) ( {i}_{b} + {i}_{b}^{2} ) t & Equation 6 \\ E = K ( {i}_{P} ) vt & Equation 7\end{matrix}$$

Some topologies of MOVs, such as Silicon Oxide Varistors, are subject to degradation over time with repeated cycling. It is therefore preferable, according to an embodiment, that the MOVs are rated several orders of magnitude above the maximum design current of each stage. For safety considerations, a double-pole single-throw (“DPST”) form-A relay in the positive and negative main current paths can optionally be added to provide galvanic isolation, as shown in FIGS. 3A, 3B, and 4B. Finally, to minimize the strain felt due to load inductance, discharge diodes on each side of the DCCB can provide a path for inductive current to flow and dissipate upon isolation, as shown in FIGS. 3A, 3B, and 4B.

For bidirectional DRER systems, the following capabilities may be built into the DCCB: manual open and manual close, overcurrent, rate of current rise (di/dt), under voltage, ground fault current interruption (“GFCI”), adaptive trip settings, and over or under power (kW) trip.

An exemplary application for this DCCB is for wave energy conversion (“WEC”) deployment requiring GFCI protection at all terminals due to residence in a subsea environment. With on-board positive and negative line current sensors, upstream and downstream voltage sensors, and high speed onboard processing, additional protective actions and functions may be readily programmable as necessary for user needs.

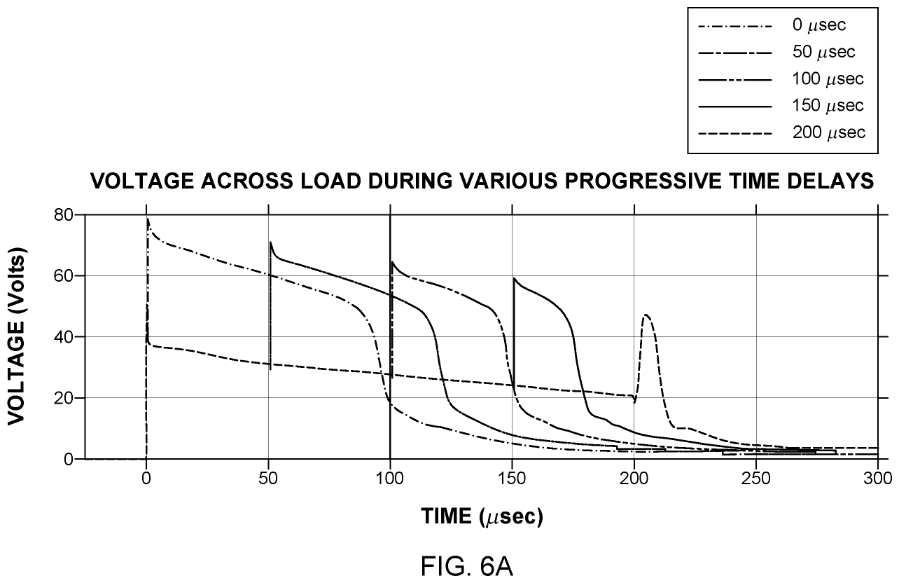

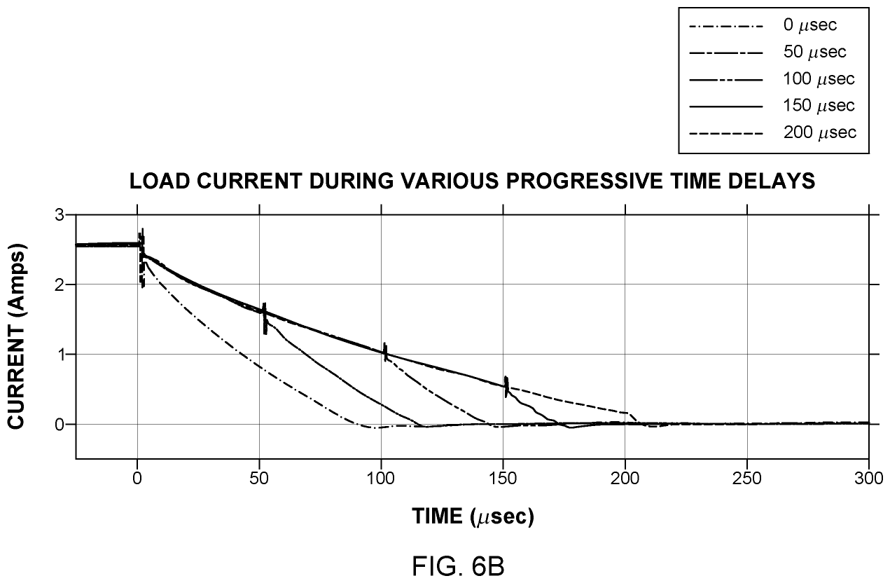

Current and voltage waveforms for isolation of an exemplary two-stage DCCB are shown in FIG. 6A and FIG. 6B. These waveforms show single-stage isolation at 0 μsec, and two-stage isolation at 50, 100, 150, and 200 μsec. The stepped voltages are clamped to 50 volts at time zero and the second stage actuation clamps the remaining voltage at the annotated time delay as shown FIG. 6A. Current commutation through the system is shown in the waveforms of FIG. 6B. These results show the correlation between voltage surges with the commutation of current through the DCCB. Distributing the surge felt during fault isolation places less strain on the DCCB components when system parameters do not allow for instantaneous fault detection. Current limiting is provided to upstream power converters, which may otherwise trip off-line due to high fault currents and subsequent voltage collapse, ensuring maximum continuity of power in DC distribution systems.

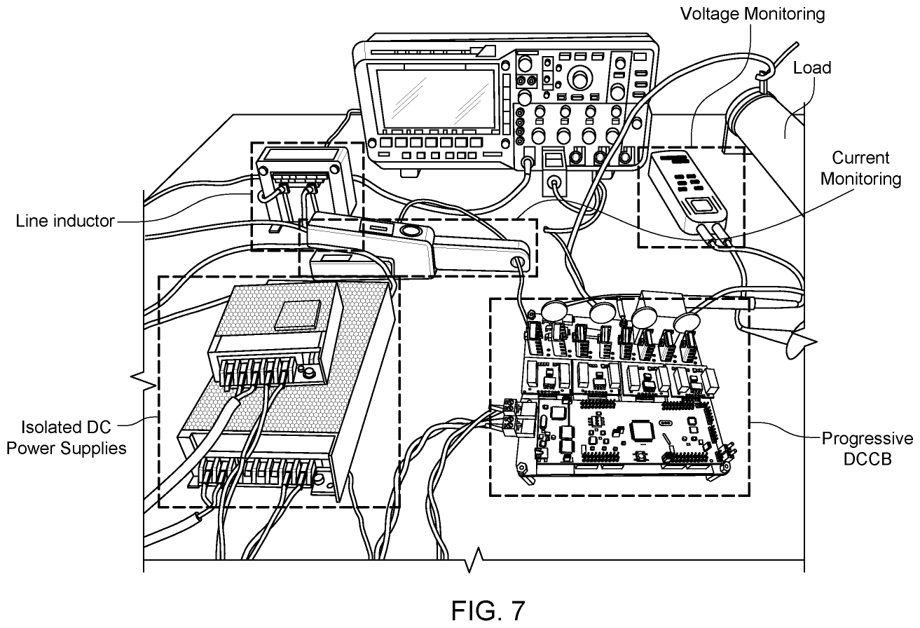

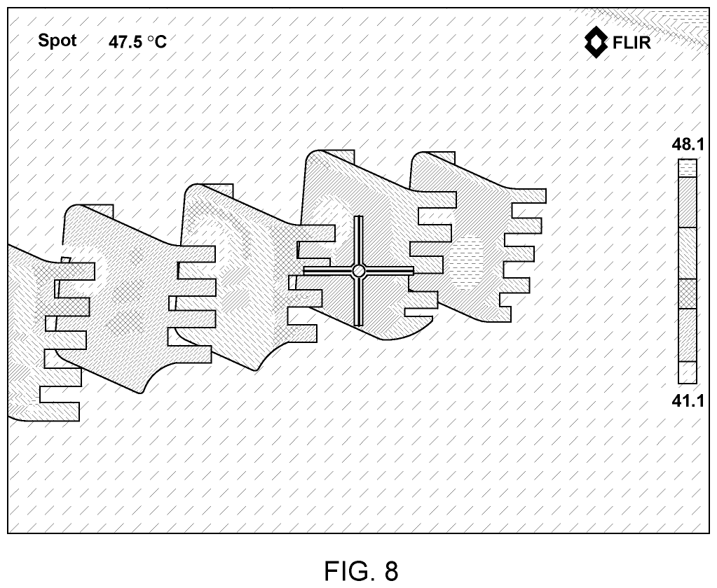

A schematic of prototype of an exemplary four-stage progressively switched DCCB, shown in FIG. 4B, was designed for and tested at 380 VDC to correspond with the laboratory low-voltage DC testing platform. Additional parameters of the test prototype, testing platform, and test conditions are shown below in TABLE I. The prototype was tested under a variety of conditions and used to validate simulation results and test control algorithms. The four-stage DCCB prototype of FIG. 4B is shown integrated to the DCCB test bench in FIG. 7. The DCCB and test bench are designed with the parameters listed in TABLE I. This prototype has been tested successfully to demonstrate the progressive shutdown and current limiting capability of the progressively switched, solid-state DCCB. The first generation prototype was tested up to 10 kW at 380 volts and monitored for performance against system design parameters. MOSFETs Q6, Q7, and Q8 in this prototype were placed perpendicular to the galvanic isolation relay. This placement makes Q6, Q7, and Q8 the thermally limiting components since it impedes cooling capabilities. Q6, Q7, and Q8 were monitored for temperature rise during steady-state operation as represented in the infrared image in FIG. 8.

TABLE I

| Component | Parameter | Units |
|---|---|---|
| V_{Source} | 380 | V_{DC} |
| I_{Load} | 25 | A_{DC} |
| R_{Load} | 15.2 | Ω |
| L_{Source} | 2.5 | mH |
| V_{MOV1-3} | 93 | V_{DC} |
| V_{MOV4} | 585 | V_{DC} |
| V_{Peak} | 864 | V_{DC} |

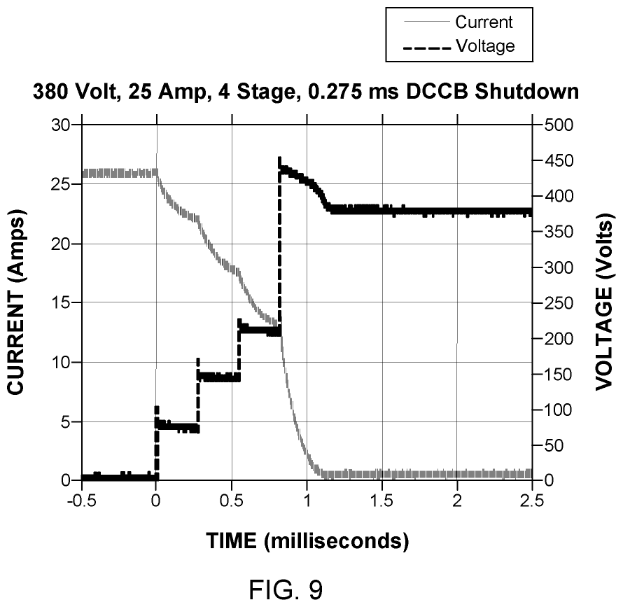

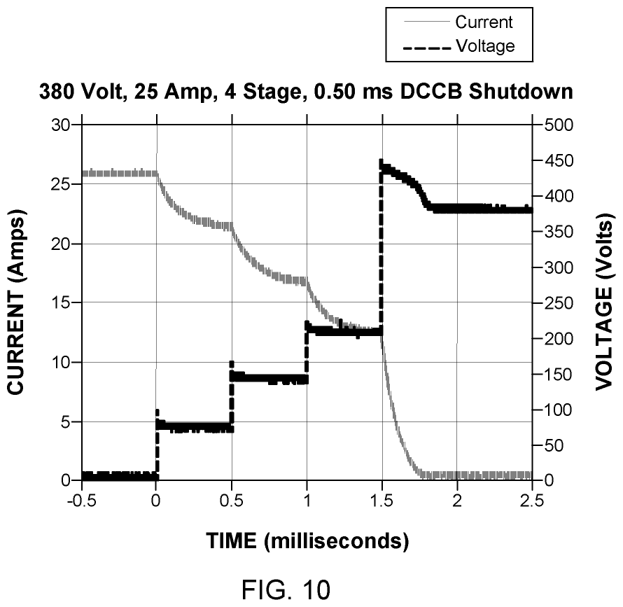

In an embodiment, surface mount device (“SMD”) MOSFETs and other package and heatsink combinations that facilitate higher power levels with improved thermal characteristics that enhance efficiency and longevity of the devices may be employed for higher power levels and continuous current operation. Steady-state isolation of the four-stage progressively switched DCCB is shown in the current and voltage waveforms of FIG. 9 at 275 μsec delay and in FIG. 10 at 500 μsec delay per stage. FIG. 6A and FIG. 6B for the two-stage prototype, and FIG. 9 and FIG. 10 for the four-stage prototype show that higher voltage surges are encountered with faster isolation. Therefore, the tradeoff is apparent with faster isolation placing higher voltage stress on the system. However, faster fault isolation may prevent voltage collapse and subsequent loss of power to the distribution system.

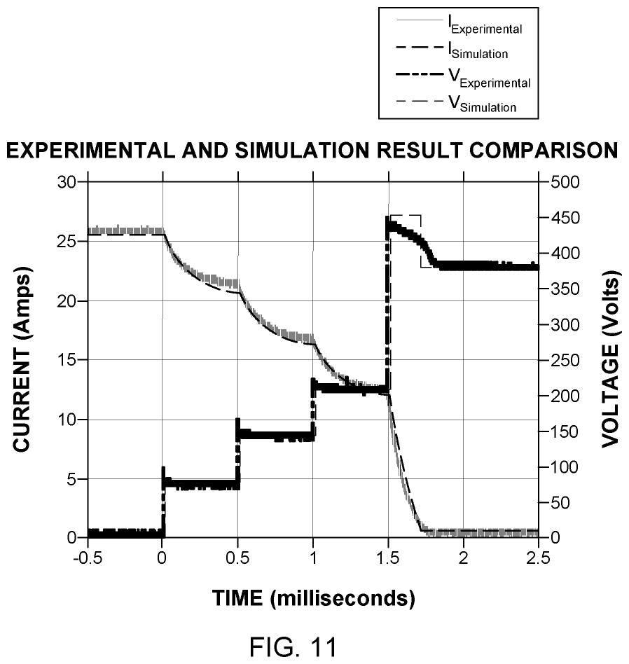

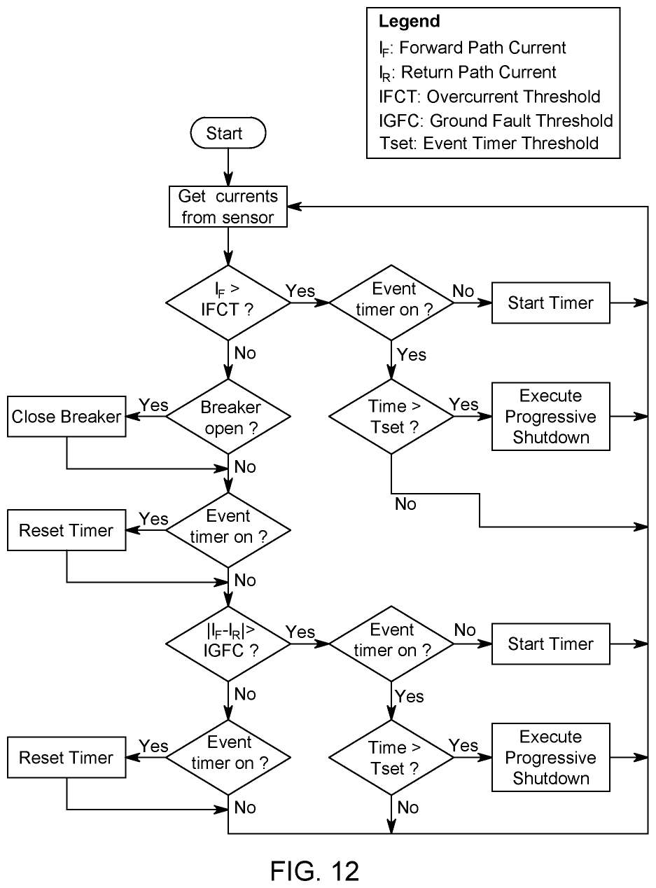

In an embodiment, FIG. 11 illustrates the 380 volt, four-stage progressively switched DCCB during a 10 kW isolation as compared to the simulation. The energy absorption of each stage, timing, and voltage clamping are consistent between the simulation (dashed lines) and experimental values (solid lines). This slight discrepancy in the decay rate of surge voltage is attributed to limitations in the model's accuracy in the varistor voltage range of the MOVs due to temperature dependence of the MOVs in the varistor voltage range.

FIG. 12 illustrates an integrated current sensing and control algorithm for a multi-stage progressively switched DCCB according to an embodiment. The algorithm employs voltage and current sensing, differential current calculation, and controls the operation of each stage of the power electronic switches from 1 through n and the galvanic isolation relay to ensure isolation from all downstream connections. When the overcurrent or ground fault thresholds are exceeded, the sensing circuit initiates the progressive shutdown control sequence, in accordance with programmed parameters, based on the devices installed and surge tolerances of the system.

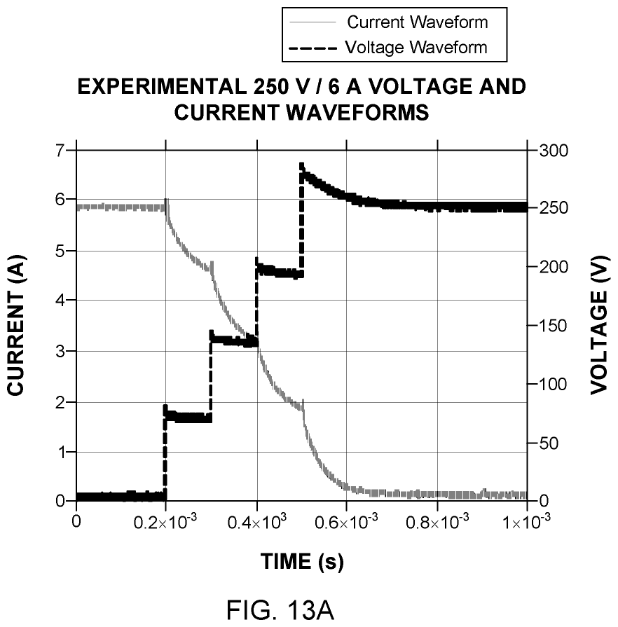

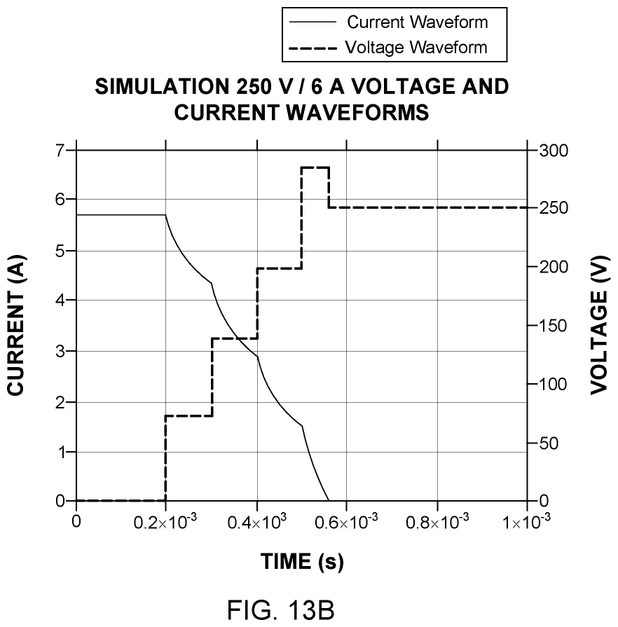

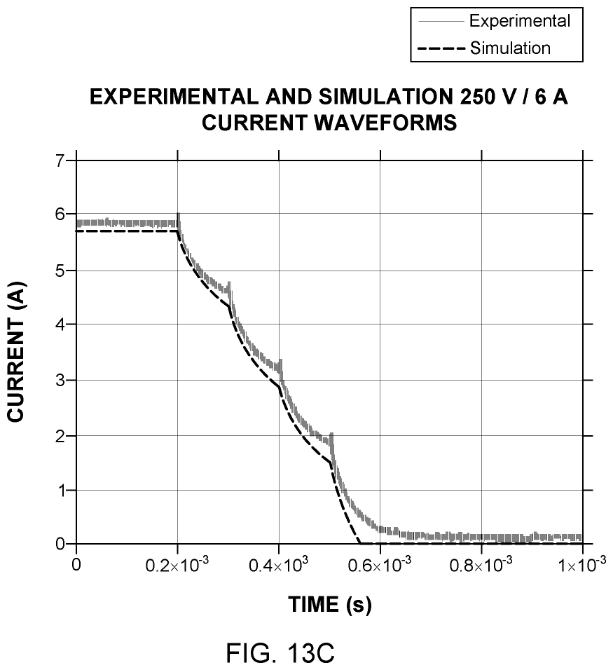

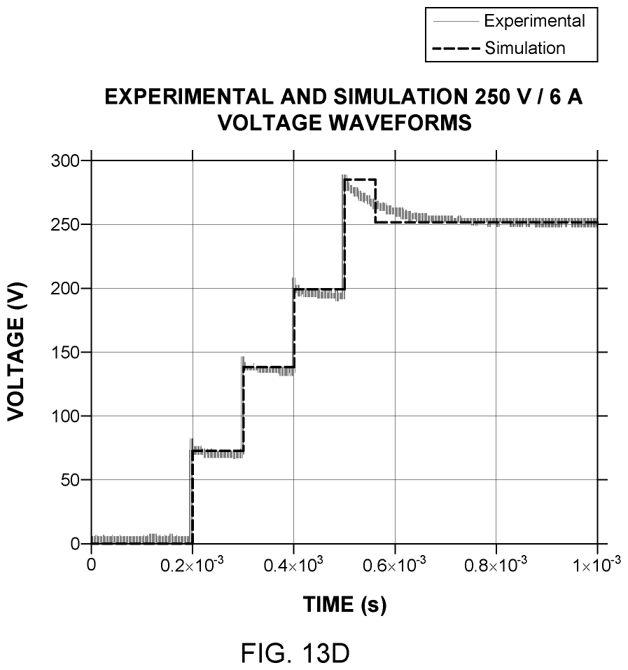

The current and voltage waveforms shown in the graphs of FIG. 13A through FIG. 13D illustrate validation of the simulation model with multiple operating parameters and illustrate the scalability of the technology through a range of low-voltage direct current (“LVDC”) operating conditions. Accurate simulation modeling is required to ensure scalability, particularly due to the non-linearity of most voltage clamping devices, including MOVs as implemented in this prototype.

Systems and methods for progressively switched solid-state direct current circuit breakers have been disclosed herein. Specifically, a new progressively switched DCCB that limits the fault current surge during system isolation is described herein. Power system and control simulation were validated in a four-stage progressively switched solid-state test prototype DCCB. Testing validated improvement in fault isolation capability. This novel design allows for DCCB design with smaller, less expensive components, specifically the power electronic MOSFETs. The progressively switched DCCB provides improved protection to upstream power electronics in DC distribution systems for enhanced continuity of power. Additionally, the design is scalable to easily achieve higher isolation voltages and higher current levels with minimal additional complication in circuit breaker design or system control.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A progressively switched solid-state direct current circuit breaker (“DCCB”), comprising:
a fault-sensing device to sense a fault condition in DC current provided to a load;
a controller configured to receive fault-sensing information from the fault-sensing device and provide control signals for progressively switching the DCCB based on the fault-sensing information;
at least two stages, each comprising:
two or more series connected power electronic switches;
two or more power electronic switches configured to interrupt control current flow through the power electronic switches responsive to receiving one of the control signals; and
a voltage clamping device configured to clamp a voltage across the two or more power electronic switches when current flow through the power electronic switches is interrupted;
wherein the at least two stages are configured to progressively clamp voltage based on the control signals;
and
at least one discharge component configured to provide a path to dissipate inductive current flow when the fault condition is cleared.

2. The DCCB of claim 1, wherein the controller includes at least one processor.

3. The DCCB of claim 2, further comprising a driver operatively connected to the power electronic switches to drive the power electronic switches based on control signals from the processor.

4. The DCCB of claim 2, wherein the at least one processor includes a digital signal processor (“DSP”).

5. The DCCB of claim 1, wherein the voltage clamping device is at least one of a varistor, fixed value resistor, resistive-capacitive snubber circuit, zener diode, gas discharge tube, and semiconductor suppressor.

6. The DCCB of claim 5, wherein the varistor is a metal oxide varistor (“MOV”).

7. The DCCB of claim 1, wherein each of the power electronic switches is at least one of a field effect transistor (“FET”), insulated gate bipolar transistor (“IGBT”), integrated gate-commutated thyristor (“IGCT”), injection-enhanced gate transistor (“IEGT”), and gate turn-off thyristor (“GTO”).

8. The DCCB of claim 7, wherein each of the power electronic switches is a metal oxide field effect transistors (“MOSFET”).

9. The DCCB of claim 1, wherein each stage includes a plurality of power control switches arranged in parallel.

10. The DCCB of claim 1, wherein the discharge component is a diode.

11. The DCCB of claim 1, further comprising a relay configured to provide galvanic isolation to the DCCB.

12. The DCCB of claim 1, wherein the DCCB includes at least one of manual open and manual close, overcurrent, rate of current rise, undervoltage, ground fault current interruption (“GFCI”), adaptive trip settings, and over or under power trip.

13. A method of progressively switching a DCCB, the method comprising:
sensing a fault condition in DC current provided to a load;
determining that a DC current threshold is exceeded for current provided to the load;
responsive to determining that the DC current threshold is exceeded, controlling a series of stages to progressively clamp voltage to limit current flow to the load; and
providing a path to dissipate inductive current flow when the fault condition is cleared.

14. The method of claim 13 further comprising providing galvanic isolation to the DCCB.

15. A non-transitory computer-readable storage medium storing instructions to be implemented by a controller having at least one processor, wherein the instructions, when executed by the at least one processor, cause the controller to perform a method to control a progressively switched solid-state direct current circuit breaker (“DCCB”) via control signals, the method comprising:
sensing a fault condition in DC current provided to a load;
determining that a DC current threshold is exceeded for current provided to the load; and
responsive to determining that the DC current threshold is exceeded, controlling a series of stages to progressively clamp voltage to limit current flow to the load, wherein the DCCB provides and a path to dissipate inductive current flow when the fault condition is cleared.

16. The method of claim 15, wherein the DCCB comprises:
a fault-sensing device to sense the fault condition; and
at least two stages, each comprising:
two or more series connected power electronic switches;
two or more power electronic switches configured to interrupt control current flow through the power electronic switches responsive to receiving one of the control signals; and
a voltage clamping device configured to clamp a voltage across the two or more power electronic switches when current flow through the power electronic switches is interrupted.

17. The method of claim 16, wherein the at least two stages are configured to progressively clamp voltage based on the control signals.

18. The method of claim 17, wherein the DCCB further comprises at least one discharge component configured to provide a path to dissipate inductive current flow when the fault condition is cleared.

19. The method of claim 18, wherein the DCCB further comprises a driver operatively connected to the power electronic switches to drive the power electronic switches based on control signals from the processor.

20. The method of claim 19, wherein the DCCB further comprises a relay configured to provide galvanic isolation to the DCCB.
